(19) United States
(12) Patent Application Publication
(10) Pub. No.: US 2003/0056106 A1
(43) Pub. Date: Mar. 20, 2003

(54) Encryption system for preventing data from being copied illegally and method of the same

(76) Inventor: Sheng E. Wang, Taipei (TW)

Correspondence Address: Sheng E. Wang, 235 Chung-Ho Box 10-69, Taipei, TW

(21) Appl. No.: 09/947,601

(22) Filed: Sep. 7, 2001

(51) Int. Cl. H04L 9/32

(52) U.S. Cl. 713/189

(57) ABSTRACT

An encryption system for preventing data from being copied illegally and the method of the same are disclosed. An adapter has an encrypted series number, a decrypting key, and a data transfer key which are built in the adapter during the manufacturing process. The adapter stores the parameters, and related files and data, decrypts the encrypted data in the storage medium so as to restore the data, selects different data output device for playing the data. The key of the adapter serves to decrypt and encrypt data as the data is exchanged. The original data in a storage medium can be deleted so as to assure only one data is in the system, and thus only one person can use the data. Therefore, the data is difficult to be copied illegally. The present invention also provides a method for performing the method.

### FIELD OF THE INVENTION

The present invention relates to data encryption, and particularly to an encryption system for preventing data from being copied illegally and a method of the same.

### BACKGROUND OF THE INVENTION

Network, especially Internet, has become a very popular tool in communication. Information are transferred through Network. Therefore, Internet is widely used all over the world. Moreover, many electronic businesses (such as music playing, electronic book transaction, charging, shopping, etc.) are transacted through Internet. Thus, the security of data transmission becomes an important problem in the data transmission through network.

Recently, a virtual controller is developed. In this controller, the encrypting code manually operated can be identified. However, since in this system, only one encrypting code is used, once this code is known by unfriendly peoples, it is very possible the data may be copied illegally. Therefore, there is an eager demand for a novel encryption system for preventing data from being copied illegally.

### SUMMARY OF THE INVENTION

Accordingly, the primary object of the present invention is to provide an encryption system for preventing data from being copied illegally and the method of the same, wherein data (for example, electronic books, music, etc.) are well protected. The data may be exchanged and copied, but only one authority is given.

A further object of the present invention is to provide an encryption system for preventing data from being copied illegally and the method of the same, wherein original data are combined with encrypting codes so as to prevent from being copied illegally to avoid too many copies of data to be prepared.

To achieve above objects, the present invention provides an encryption system for preventing data from being copied illegally and the method of the same, wherein an adapter has an encrypted series number, a decrypting key, and a data transfer key which are built in the adapter in the manufacturing process. The adapter stores the parameters, and related files and data, decrypts the encrypted data in the storage medium so as to restore the data, selects different data output device for playing the data. The key of the adapter serves to decrypt and encrypt data as the data is exchanged. The original data in a storage medium can be deleted so as to assure only one data is in the system, and thus only one person may use the data and therefore, the data is difficult to be copied illegally. The present invention also provides a method for performing the method.

The various objects and advantages of the present invention will be more readily understood from the following detailed description when read in conjunction with the appended drawing.

### BRIEF DESCRIPTION OF THE DRAWINGS

FIG. 1 is a schematic view includes the embodiment of the present invention.

FIG. 2 is a schematic view showing the encryption of the data section of the present invention.

FIG. 3 is a flow diagram showing the encryption of the adapter and the storage medium of the present invention.

FIG. 4A is a flow diagram showing that in the present invention, the data is written into the storage medium.

FIG. 4B is a flow diagram showing that in the present invention, the data is read from the storage medium.

FIG. 5 is a flow diagram showing the data exchange process of the storage medium in the present invention.

FIG. 6 is a schematic view showing the data exchange and copying in the present invention.

### DETAILED DESCRIPTION OF THE PREFERRED EMBODIMENTS

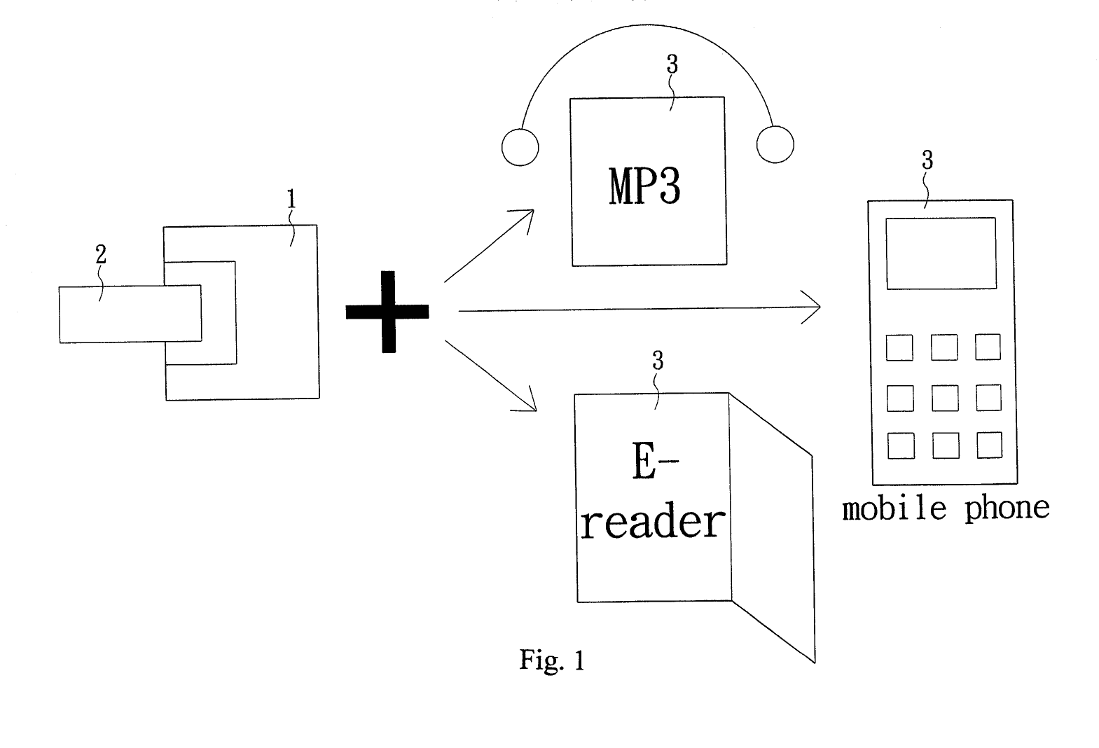

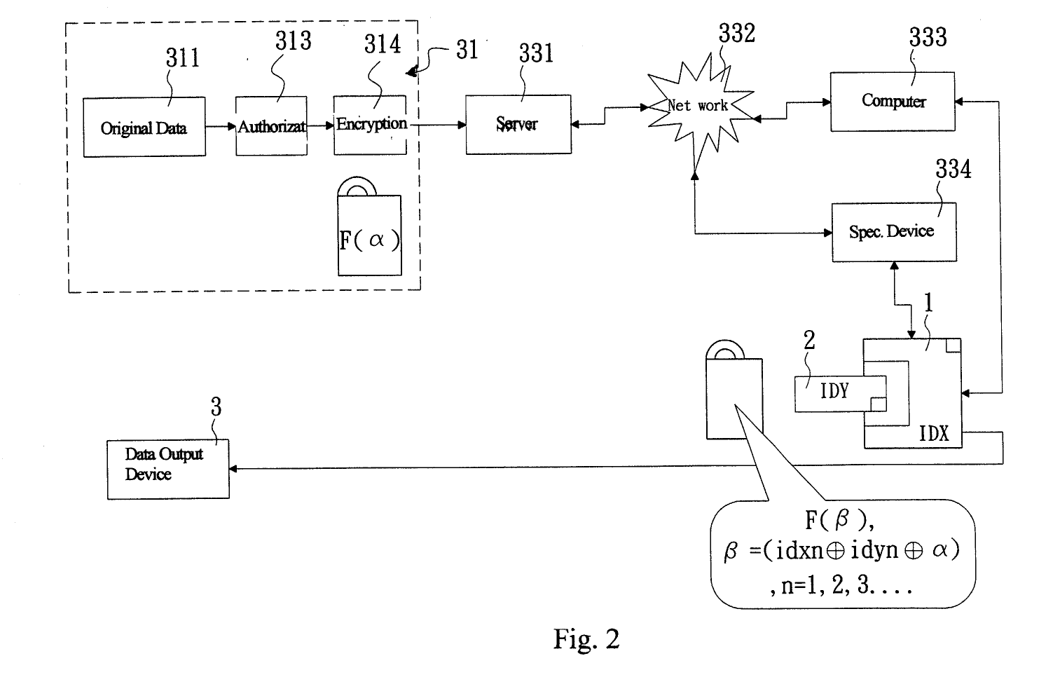

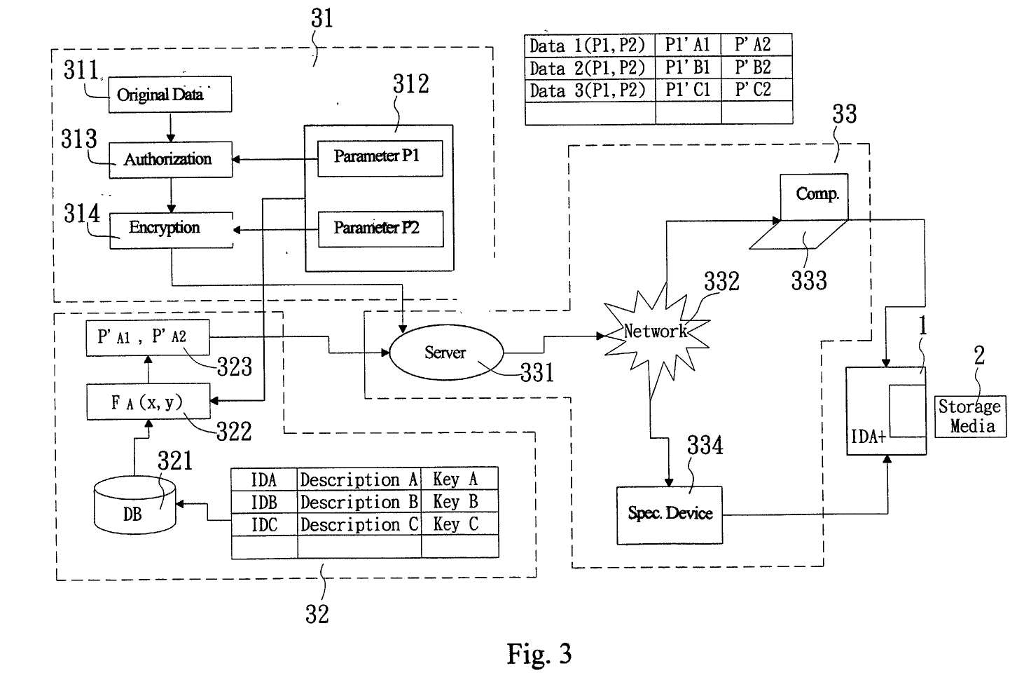

Referring to FIGS. 1, 2, and 3, a method of the present invention is illustrated. The adapter 1 of the present invention is built with an encrypting series number IDn, a decrypting key Key n, and a Key nn for data transfer and for copying the data. The encrypted data (for example, electronic book, music, etc.) in the storage medium 2 are decrypted by the stored parameters P1, P2 and related files and data. Thereby, a data output device 3 may play and output said data. The details will be described in FIGS. 2 and 3.

The data section 31 includes original data 311 (comprising general electronic book, MP3, music, etc. and parameters P1, P2 (312). In that the original data 311 is combined and encrypted with the parameters P1, P2 (312) for assuring that the authorized adapter (subscriber) may be used safely. In the process, the original data 311 is added with a parameter P1. Then the data is authorized, and then is added with a parameter P2 for encryption 314. Then, the encrypted data is transferred to the server 331.

A managing section 32 includes a database 321. The managing section 32 serves to store the authorization series numbers (for example, IDA, IDB), and the correspondent data contents (for example, Description A, Description B), and passwords (for example, Key A, Key B) in the database 312. The database 321 performs a transfer operation 322 [Fn (X, Y)] to the data content (IDA) and parameters P1, P2 for generating two parameters 323 P'ₙ₁ and P'ₙ₂. Then the result is transferred to the server 331 for being used by the adapter 1 and the storage medium 2. Since Key A is set in the manufacturing process, the data in the storage medium can not be decrypted and played since Key A is not transferred even it is captured in the network. Therefore, the user may use the data safely, where the lower case “n” is the number of the adapter. For example adapter IDA has the respective parameters P'_{A1} and P'_{A2}. Moreover, different adapter has different parameters P'ₙ₁ and P'ₙ₂.

An interface section 33 includes a server 331, a proprietary network management path 332, a computer 333, and a specific device 334. In this section, the server 331 authenticates the adapter 1 and the storage medium 2 connected to the computer or specific device through the proprietary network, and checks whether the adapter 1 and storage medium 2 are authorized. Once they are authenticated, the adapter 1 and the storage medium 2 may receive data through the server 331 and network.

The adapter 1 has an encrypted series number IDn, a decrypting key Key n, and a data transfer key Key nn (where n is the respective series number of the adapter) which are built in the adapter 1 in the manufacturing process. The adapter 1 stores the parameters P1, P2, and related files and data, decrypts the encrypted data in the storage medium 2 so as to restore the data, selects different data output device for playing the data (For example, MP3 players, electronic book readers, PDAs, or other Audio/Video players).

The Key nn built in the adapter 1 is utilized when data (such as electronic books, or music) is transferred or copied for preventing the data from being used illegally by using the Key n. Therefore, the built in Key nn has the function of security in data transmission. The adapter 1 may be a card reader or other portable read/write (R/W) devices. The storage medium 2 may be a magnetic card, an IC cards, a smart card, a complete magnetic card, an optic card, a memory card, or other portable devices for data storage. The storage medium 2 serves to store data encrypted through the parameters P1, P2.

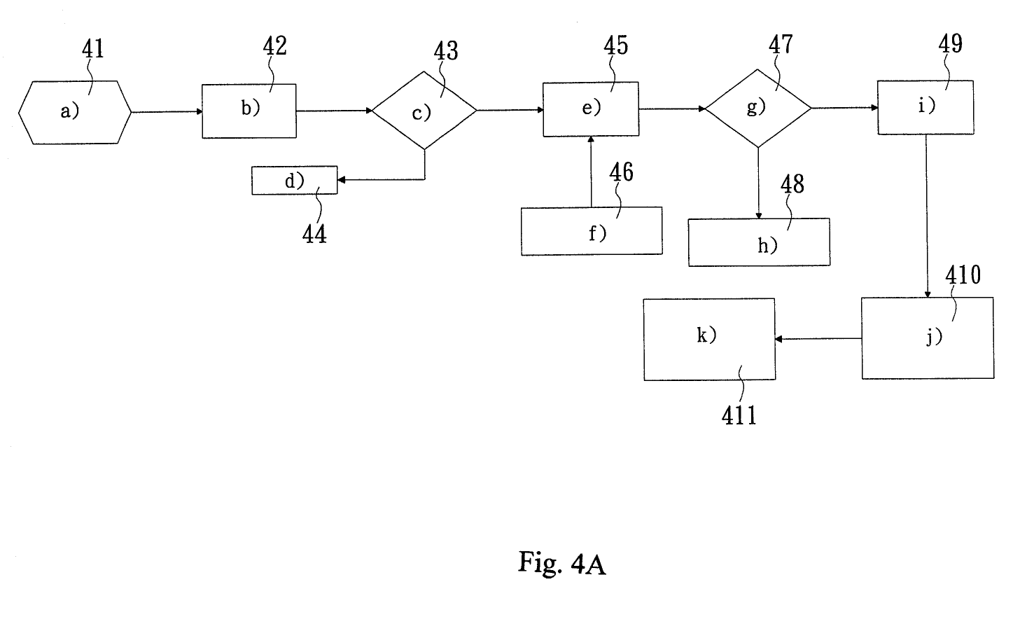

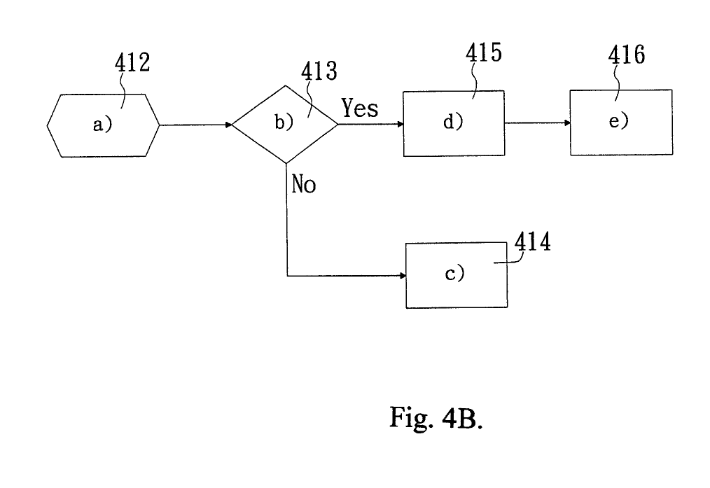

Referring to FIG. 4A, the process of data reading and writhing of the present invention is illustrated. The process comprises the following steps.

a) step 41: Connect an adapter and a storage medium to a computer or a specific device.

b) Step 42: Authenticate the series number ID of the adapter.

c) Step 43: Determine whether the adapter is authorized? If no, the process performs a step d), otherwise the process enters into step e).

d) Step 44: Reject the adapter for rejecting those not manufactured by the manufacturer.

e) Step 45: The server receives data through a network, or through the following Step f).

f) Step 46: Receiving data.

g) Step 47: Determining whether the format of the received data is legal? If yes, the process enters into i), otherwise, into h).

h) Step 48: Stop the process, and emit a warning signal.

i) Step 49: Decrypt the parameters P'_{A1} and P'_{A2} through the encrypting key Key A built in the adapter IDA for acquiring parameter P1, P2.

j) Step 410: Write parameter P1, P2 and related files and data into the adapter.

k) Step 411: encrypt the data through the parameters P1, P2 and then store the data in the storage medium.

Further referring to FIG. 4B, the reading process of the storage medium in the present invention is illustrated. The process includes the following steps.

a) Step 412: Connect the storage medium to the adapter.

b) Step 413: Determine whether the data format of the storage medium is matched to that of the adapter? If yes, step c) is performed, otherwise step d) is performed.

c) Step 414: Stop the process and emit a warning signal.

d) Step 415: decrypt the encrypted data in the storage medium through the parameters P1, P2 in the adapter.

e) Step 416: output data in the storage medium for playing.

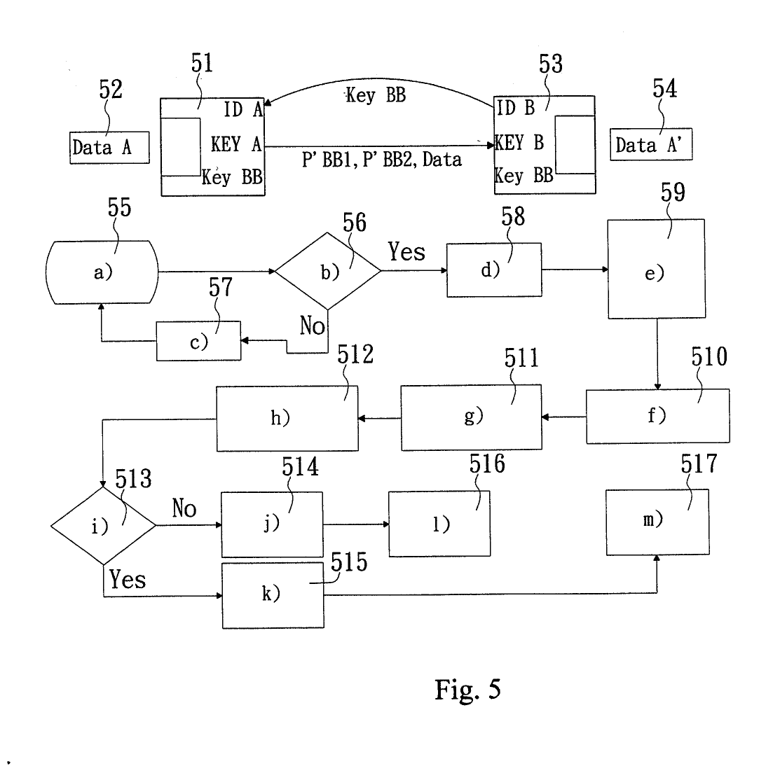

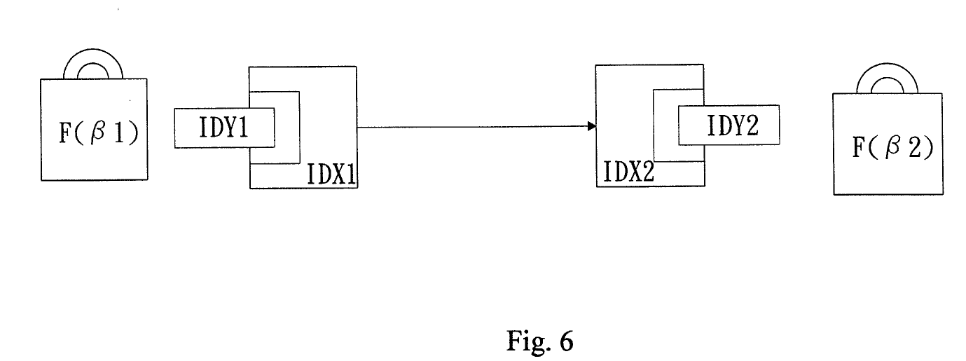

Referring to FIGS. 5 and 6, the data (for example, electronic books, music, etc.) in the storage medium can be exchanged and copied directly. Two adapters may be connected to two storage mediums. One set has an adapter IDA for transfer data to be exchanged and a storage medium A storing data AA, and the other is an adapter IDB for receiving the data and a storage medium B. When the original data of the storage medium A is transferred directly to the storage medium B, the data AA can be repacked by the transfer function F'(P'BBI, P'BB2), and the original data in storage medium A is deleted for assuring only one person to be authorized to use the data. Therefore, it has the advantage of preventing the data from being copied so as to protect the right of the supplier. The process for data exchange is described in the following.

a) Step 55: Start data exchange process.

b) Step 56: Determine whether the adapter IDB is authorized? If no, the process enters into the step c); otherwise, step d) is performed.

c) Step 57: Emit a warning signal.

d) Step 58: Transfer a data exchange key Key BB from the adapter IDB to the adapter IDA.

e) Step 59: repack data AA as data AA' and parameters P1 and P2 as P'BB1 and P'BB2 by the transfer function.

g) Step 511: Store the parameters P'BB1 and P'BB2 and the related files and data AA' in the adapter IDB.

h) Step 512: Store the data A' in the storage medium B.

i) Step 513: Assure whether the adapter IDB has completed the data exchange process? If no, step j) is performed. If yes, step k) is performed.

j) Step 514: Delete the parameters P'BB1 and P'BB2 in the adapter IDB, 53, and then the process enters into the step l).

k) Step 515: delete the parameters P1, P2 in the adapter IDA and remove the data A in the storage medium A, and then the process enters into the step m).

l) Step 516: emit a failure warning.

m) Step 517: complete the data exchange process.

The advantages of the present invention is:

1. The data (for example, electronic books, music, etc.) are well protected.

2. The data may be exchanged and copied, but only one authority is given.

3. The original data are combined with encrypting codes so as to prevent from being copied illegally.

4. It can avoid too many copies of data to be prepared.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An encryption system for preventing data from being copied illegally; the system having parameters P1, and P2, and a plurality of authorizing series numbers, comprising
a data section including original data; the original data being combined and encrypted through the parameters P1, P2 for assuring that only authorized adapters can use the data safely; wherein the original data is added with the parameter P1; then the data is authorized, and then is added with the parameter P2 for encryption; then, the encrypted data are outputted;
a managing section including a database for storing the plurality of authorizing series numbers, the correspondent data contents, and passwords in the database; wherein the database performs a transfer operation to the data and parameters P1, P2 for generating two parameters P'ₙ₁ and P'ₙ₂, then the results are outputted to a server;
an interface section including the server, a proprietary network management path, a computer, and a specific device;
the adapter containing a series number IDn, a decrypting key Key n, and Key nn for data transfer and copy which are built in the adapter during a manufacturing process; the adapter stores the parameters P1, P2, and related files and data, decrypts the encrypted data in the storage medium so as to restore the data, selects different data output device for playing the data; and
a storage medium for storing encrypted data to be decrypted by the adapter and related files and data; thereby, a data output device playing and outputting said data;
wherein the adapter transfers a series number ID to the server through the computer or the specific device, and then the server checks whether the adapter and the storage medium are authorized; once they are authenticated, the adapter and the storage medium receive data through the server and the propriety network;

2. A method for encrypting data utilized in a data transfer system for preventing data from being copied illegally; the system comprising a data section having original data to be transferred, a managing section having a database for storing the plurality of authorizing series numbers, a plurality of data contents correspondent to the series numbers, and a plurality of passwords, and an interface section including a server, a proprietary network management path, a computer, and a specific device; at least one adapter containing a series number IDn, a decrypting key, and a data transfer and copying key which are built in the adapter during a manufacturing process; at least one storage medium for storing encrypted data to be decrypted by the adapter and related files and data; the system having parameters P1, and P2, and a plurality of authorizing series numbers; the method comprising the steps of:
adding the original data with the parameter P1; then authorizing the data added with the parameter P1, and then the adding the authorized data with the parameter P2 as encrypted data; then, outputting the encrypted data;
performing a transfer operation to the data in the database and parameters P1, P2 for generating two parameters P'ₙ₁ and P'ₙ₂, then the result is transferred to the server;
transferring a series number ID from the adapter to the server through the computer or the specific device, and then the server checks whether the adapter and the storage medium are authorized; once they are authenticated, the adapter and the storage medium receive data through the server and the propriety network;
storing the parameters P1, P2, and related files and data in the adapter, decrypting the encrypted data, and thus restoring the data, selecting a different data output device for playing the data; and
storing encrypted data and related files and data in the storage medium; thereby, wherein if desired, the data storing in the storage medium is read out to the adapter.

3. The method of claim 2, wherein the step of storing data in the storage medium comprising the steps of:
a) connecting an adapter and a storage medium to a computer or a specific device;
b) the server authenticating a series number of the adapter.
c) the server determining whether the adapter is authorized? if no, the process performs the following step d; if yes, the process enter into step e.
d) the server rejecting the adapter;
e) the server receiving data through a network, or through the following step f;
f) the adapter receiving data;
g) the adapter determining whether a format of the received data is legal? if yes, the process enters into i), otherwise, into h);
h) stopping the process, and emit a warning signal;
i) decrypting the parameters P'ₙ₁ and P'ₙ₂ from the management section through the decrypting key built in the adapter for acquiring parameter P1, P2;
j) writing parameter P1, P2 and related files and data into the adapter; and
k) encrypting the data using the parameters P1, P2 in the adapter and then store the data in the storage medium.

4. The method of claim 3, wherein the step of reading data from the storage medium comprising the steps of:
a) connecting the storage medium to the adapter.
b) determining whether the data format of the storage medium is matched to the adapter? if yes, step c) is performed, otherwise step d) is performed.
c) stopping the process and emit a warning signal.
d) decrypting the encrypted data in the storage medium through the parameters P1, P2 in the adapter.
e) outputting data in the storage medium for playing.

5. The method of claim 1, wherein the data in the storage medium is exchanged and copied directly; two adapters are connected to two storage mediums; one of the adapters IDA for transferring data to be exchanged and one of the storage mediums is a storage medium A for storing data AA, and the other adapter IDB serves for receiving the data and the other storage medium is a storage medium B for transferring data; when the original data of the storage medium A is transferred directly to the storage medium B, the data AA can be re-encrypted by a transfer function, and the original data in storage medium B is deleted for assuring only one person to be authorized to use the data; therefore, it has the advantage of preventing the data from being coped so as to protect a right of a supplier; the above process comprising the steps of.
a) beginning data exchange process.
b) determining whether the adapter IDB is authorized? if no, the process entering into the step c); otherwise, step d) being performed.
c) emitting a warning signal;
d) transferring a data exchange key from the adapter IDB to the adapter IDA;
e) re-packing data AA as data AA' and parameters P1 and P2 as P'BB1 and P'BB2 by the transfer function;
g) storing parameters P'BB1 and P'BB2 and the related files and data AA' in the adapter IDB;
h) storing the data AA' in the storage medium B;
i) assuring whether the adapter IDB has finished the data exchange process? If no, step j) is performed. If yes, step k) is performed.
j) delete the parameters P'BB1 and P'BB2 in the adapter IDB, and then the process enters into the step l).
k) delete the parameters P1, P2 in the adapter IDA and remove the data A in the storage medium A, and then the process enters into the step m).
l) emit a failure warning.
m) ending the data exchange process.
